(19) United States
(12) Patent Application Publication
(10) Pub. No.: US 2012/0325623 A1
(43) Pub. Date: Dec. 27, 2012

(54) Method and Device for Selectively Tipping Objects

(75) Inventor: Ludger Polling, Wadersloh-Diestedde (DE)

(73) Assignee: BEUMER GMBH & CO. KG, Beckum (DE)

(21) Appl. No.: 13/576,009

(22) PCT Filed: Jan. 31, 2011
(86) PCT No.: PCT/DE2011/000095

§ 371 Date: Aug. 27, 2012

(30) Foreign Application Priority Data
Feb. 1, 2010 (DE) 20 2010 001 853.6

(51) Int. Cl. B65G 47/248

(52) U.S. Cl. 198/411

(57) ABSTRACT

An apparatus for selectively tipping over an article with a standing surface, when it is standing on a conveying surface extending in a longitudinal direction and being moved in the longitudinal direction, onto a lateral surface, wherein over at least 90% of its width, the conveying surface, proceeding from an initial orientation, passes over into a tilting region which extends from a starting position in the longitudinal direction as far as a final position, at which the conveying surface has an angle of inclination transverse to the longitudinal direction which is at least 5° and no more than 30° to the horizontal. Also a method for selectively causing a gravity-induced process for tipping an article from a standing surface on which the article is being moved in a longitudinal direction on a conveying surface extending in the longitudinal direction onto a lateral surface.

### CROSS-REFERENCE TO RELATED APPLICATIONS

This application in a national stage filing of PCT/DE2011/000095 which claims priority from DE 20 2010 001 853.6 filed on Feb. 1, 2010 in Germany.

### TECHNICAL FIELD

The invention relates to a method and apparatus for selectively tipping over an article with a standing surface, when it is standing on a conveyor surface extending in the longitudinal direction and being moved in the longitudinal direction, onto a lateral surface, wherein those articles are supposed to be purposively tipped over which tend to tip over in any case because of the position of their centre of gravity compared to their standing surface, in order in this way to avoid uncontrolled tipping over.

### BACKGROUND OF THE INVENTION

In order to transport articles such as items of luggage at airports, for example, it is desirable with most conveying and sorting systems to transport the articles lying down. This is intended to prevent the article from tipping over on the conveyor system in an uncontrolled manner during transport, especially when accelerating, braking or cornering or travelling along sloping surfaces. If an article tips over in an uncontrolled manner during transport, this might, on the one hand, result in an undefined position of the article on the conveyor system, thus presenting an obstacle to other articles, and, on the other hand, could cause the article to fall down or off the conveyor system, quite apart from the possibility of damage to the article itself.

It is therefore normally necessary to ensure immediately after an item of luggage has been handed in at a luggage drop-off counter that any items of luggage still standing are placed in a lying position. A variety of devices are already known from practice for this purpose. In one embodiment, a downwardly tapering conical roller is disposed to the side of the conveyor belt so as to be rotatable about a vertical axis, an upper portion of the conical roller extending across part of the conveyor belt. An approaching item of luggage first comes into contact with the conical roller with its upper corner facing the conical roller. As it moves forward, the upper longitudinal edge of the item of luggage facing the conical roller slides along the conical roller, causing the item of luggage to tilt more and more and to fall on its side after passing the unstable centre of gravity. In terms of tipping items of luggage onto their side, the conical roller has one disadvantage in particular, namely that it is of only limited effectiveness on straight stretches. Particular problems occur if the item of luggage exceeds a critical width. In addition, the item of luggage is subjected to relatively great stress during the process of being turned onto its side. Another known means for turning items of luggage onto their side is a chain curtain above the conveyor belt, which is attached to a horizontal, rigid transverse beam extending at an angle to the conveying direction. An upright item of luggage travelling through the chain curtain comes into contact with some of the chains, moves them out of their rest position and is then pushed onto its side by the restoring force of chains sliding off on one side. The chain curtain does not always operate safely and reliably, especially in the case of large-volume and light items of luggage.

In addition, conveyor belts are known which can be pivoted transversely to the conveying direction and, as they pivot, cause an item of luggage standing on them to tip over, a further conveyor belt running parallel usually being needed to receive the item of luggage which has tipped over. A disadvantage with regard to using a pivoting belt of this kind is the high investment and operating costs. A further development of the chain curtain is a guide rail, which consists of a cylindrical solid body running horizontally at an angle to the conveying direction, which is pivotably mounted beneath a horizontal support. An item of luggage running into the guide rail causes the solid body to swing to the side until the restoring force of the solid body reaches a critical magnitude and causes the item of luggage to tip over. As with the chain curtain, this system does not always operate safely and reliably, especially in the case of large-volume and light items of luggage.

EP 0 704 392 B1 disclose a tipper for wheeled luggage, with a conveyor belt forming a V-shaped channel. The disadvantage here is that articles arriving in the middle, which are actually supposed to be tipped over, might possibly travel through without being tipped over.

The object of the present invention is to provide an apparatus for laying items of luggage on their sides, the structure of which is as simple and inexpensive as possible, but which nevertheless possesses great operational safety and reliability and causes articles which should be tipped over because of their centre of gravity relative to their standing surface, to tip over in a defined manner.

### BRIEF SUMMARY OF THE INVENTION

This object is achieved according to the invention by an apparatus in accordance with claim 1 and a method in accordance with claim 12. The maximum angle of inclination of the tilting region may be 10°, 15°, 20° or 25° for example, a maximum angle of 15°-20° having proven advantageous. The initial orientation at the starting position may be horizontal, seen transversely to the longitudinal direction.

The conveying surface must be configured such that the articles placed at an inclined angle can indeed tip over and do not merely slide off to the side. For this purpose, the conveying surface may be coated with an anti-slip coating or be made from an anti-slip material such as rubber. Alternatively or in addition, the conveying surface may have profiling or projections to prevent items from sliding off. In at least one longitudinal position of the conveying surface, the tilting region preferably extends over at least 90% or 95% or over the full width of the conveying surface, so that no article has the possibility of travelling through past the tilting region, even if it is positioned right at the edge of the conveying surface.

Within the sloping region, the conveying surface is configured to slope upwards or downwards in one and the same direction, so that an inclined surface is formed with a single sloping direction, which may vary locally in its angle of inclination, unlike trough-like arrangements with opposing sloping directions.

Especially when the conveying surface is formed by a belt or strap conveyor supported by a bearing or sliding plate or by a smooth, low-friction surface such as a sliding plate, “continuous” means that beginning with the initial orientation of the conveying surface, which may, for example, be horizontal in its starting position when seen in the transverse direction, the conveying surface travels through the tilting region without steps until it reaches the final position, whereas in the case of a roller conveyor or a roller track, the route to the final position can be implemented by a number of adjacent rollers succeeding one another in the longitudinal direction and inclined more and more steeply in a series of steps. In each case, the conveying surface may be configured as a sliding plate or as a belt or roller conveyor, or as a sliding surface, in which friction-reducing elements, such as rollers, balls or belts, are integrated.

In the apparatus, the conveying surface may be configured as a belt conveyor with a support means sloping in the transverse direction disposed in the path of the belt, which may, for example, be a support roller or support plate.

It can be contemplated for the conveying surface to be configured as a belt conveyor with a conveyor belt guided at a first end over a first horizontal support roller and at an opposite second end over a support means sloping by at least 5° in the transverse direction, which may in particular be a support roller or a support plate. The conveyor belt then forms a continuous conveying surface passing over into a sloping orientation (tilting region).

It may be contemplated that a collecting region is formed transversely to the longitudinal or conveying direction offset next to the conveying surface, especially next to the tilting region, especially in the form of a collecting conveyor, the collecting-conveying surface of which may run horizontally.

It may also be contemplated that a receiving conveyor is disposed following the final position of the tilting region of the conveying surface, seen in the longitudinal direction, the receiving-conveying surface of which runs at a height corresponding to the height of the tilting region at the starting position of the latter.

In such an arrangement, with an offset in height between the final position or the discharge end of the tilting region and the receiving conveyor, it may be advantageous for the receiving conveyor to have a longitudinal or conveying direction transverse to that of the conveying surface.

As a further possibility, it may be contemplated that a receiving conveyor is disposed adjacent to the final position of the tilting region, seen in the longitudinal direction, the receiving-conveying surface of which follows on from the tilting region in the final position, in particular continuously or without a step, and passes over into a horizontal orientation, seen in the transverse direction. An arrangement of this kind is advantageous especially in those cases in which there is an unmoving, especially horizontal receiving surface disposed adjacent to the receiving conveyor, in order to take over the articles.

It may be contemplated that within the tilting region, the apparatus comprises a belt conveyor, with a conveyor belt which is guided over a first support means, such as a support or diverting roller, and over a second support means, such as a support or diverting roller, there being at least one support means, in particular a support roller or support plate, inclined by at least 5° and no more than 30° in the transverse direction disposed beneath the conveyor belt between the first and second support means, and extending between opposing side edges of the conveyor belt.

In this context, it may be contemplated for there to be disposed adjacent to the support means a further support means, which extends from a starting point located between lateral edges of the conveyor belt as far as an elevated end point located in the region of a lateral edge of the conveyor belt, wherein the starting point may be at the height of one of the support means. In particular, the support means may be arranged parallel to one another, for example as parallel support rollers.

In all the variants, it is possible for the angle of inclination of the conveying surface to be adjustable continuously or in stages within the tilting region.

In addition, it is convenient for there to be an actuating means which is coupled to a contour detecting means disposed upstream of the tilting region for detecting at least two dimensions of an article to be tipped over as necessary, said actuating means being provided in order to adjust the angle of inclination of the conveying surface so that, for example, the height and width of an article or the dimensions characterising its tendency to tip over can be detected and, for example, the conveying surface is only tilted if tilting is desired, such as only as of a predetermined ratio of height to width, and is then only tilted as far as a necessary angle of inclination, which can be determined depending on the dimensions mentioned, or may be predetermined and can vary.

In the method of the invention, it may be contemplated that the article, beginning in a horizontal orientation of its standing surface, is moved continuously or step by step into an inclined orientation.

In addition, it is possible for at least two dimensions of the article to be detected, especially contact-free, before the article reaches a final position of the tilting region, and for the angle of inclination of the tilting region to be adjusted, depending on the dimensions detected, before the article reaches the final position.

### BRIEF DESCRIPTION OF THE DRAWINGS

The invention will now be explained in more detail by describing some worked embodiments, reference being made to a drawing, in which:

FIG. 1 shows a schematic perspective representation of a first embodiment with a belt conveyor,

FIG. 2 shows an embodiment corresponding to FIG. 1 with a roller conveyor,

FIG. 3 shows a schematic perspective view of a second embodiment with a belt conveyor,

FIG. 4 shows an embodiment corresponding to FIG. 3 with a roller conveyor,

FIG. 5 shows a schematic perspective view of a third embodiment with a belt conveyor,

FIG. 6 shows an embodiment corresponding to FIG. 3 with a roller conveyor,

FIG. 7 shows a schematic perspective representation of a fourth embodiment with a belt conveyor,

FIG. 8 shows an embodiment corresponding to FIG. 7 with a roller conveyor,

FIG. 9 shows a fifth embodiment with a belt conveyor,

FIG. 10 shows a representation corresponding to FIG. 9 with a roller conveyor,

FIG. 11 shows a schematic perspective representation of a sixth embodiment with a belt conveyor, and

FIG. 12 shows a representation corresponding to FIG. 11 with a roller conveyor.

### DETAILED DESCRIPTION OF THE INVENTION

FIG. 1 shows schematically a first embodiment, in which a conveyor belt 2 forming a conveying surface 3, a tilting region 3a and a collecting region 9 is guided continuously between two first and second support or diverting rollers 6, 8 arranged horizontally and parallel to one another transversely to the longitudinal or conveying direction 4. Upstream of the conveyor belt 2, the conveying surface 3 may be formed by a further belt conveyor (indicated by dashed lines). Alternatively, a partition between the conveying surface and the collecting region or the like may be provided in order to ensure that arriving articles are located exclusively within the conveying surface and reach the tilting region in every case and, if the geometrical conditions or those concerning the centre of gravity apply, are caused to tip over.

Disposed beneath the conveyor belt 2, or more precisely beneath its carrying run, there is a support means in the form of a support roller 12 running in the transverse direction 10, perpendicularly to the longitudinal direction 4 when seen from above. The axis of rotation 14 of the support roller 12 extends, when seen vertically from above, either in the transverse direction 10 or at an acute angle β (up to about 10°) thereto, and inclined transversely to the longitudinal direction 4 at an angle of inclination Φ to the horizontal 16, which ranges between 5° to 30°. In the embodiment illustrated, axes of rotation 18, 20 of the support rollers 6, 8 are arranged horizontally, although this is not essentially necessary. The axes of rotation 18, 20 may, for example, have a slight transverse orientation in the opposite direction to the axis of rotation 14, such as 5° or 10°, in order better to catch an article deliberately caused to tip over and to prevent it from sliding in the transverse direction following the tipping procedure.

The arrangement of the support roller 12 inclined obliquely between the support rollers 6 and 8 ensures that the conveying surface 3, beginning at the first support roller 6, gradually or continuously moves over into an orientation that is inclined or more steeply inclined than the support roller 6 and forms a tilting region 3a, which begins in the example illustrated in the right-hand edge portion of the conveyor belt and continues to beyond the width of the support roller 12. Adjacent to the support roller 12, the tilting region 3a of the conveying surface 3 gradually passes back over into a less sharply inclined or horizontal course, and does so gradually as far as the right-hand edge portion of the second support roller 8.

In one variant, it may be contemplated that the support roller 12 has an adjustable angle of inclination Φ, or that it can be moved from a horizontal orientation, in which the path of the belt is not influenced at all, or not very much, into an inclined orientation.

Likewise, it may be contemplated that the horizontal angle β of the support roller 6 to the transverse direction 10 can be adjusted or specifically set.

FIG. 2 shows an arrangement analogous to that of FIG. 1, in which the continuous surface of the conveyor belt 2 is merely replaced by a corresponding arrangement of driven or non-driven rollers after the manner of a roller conveyor, wherein horizontal rollers 22 and obliquely inclined rollers 24 are used. Here too, it may be contemplated that the angle of inclination Φ of the obliquely inclined rollers to the horizontal 16 and/or the angle β to the transverse direction 10 can be adjusted or specifically set in order to provide either the arrangement shown, which is in part obliquely inclined, or an arrangement which is not inclined in the transverse direction.

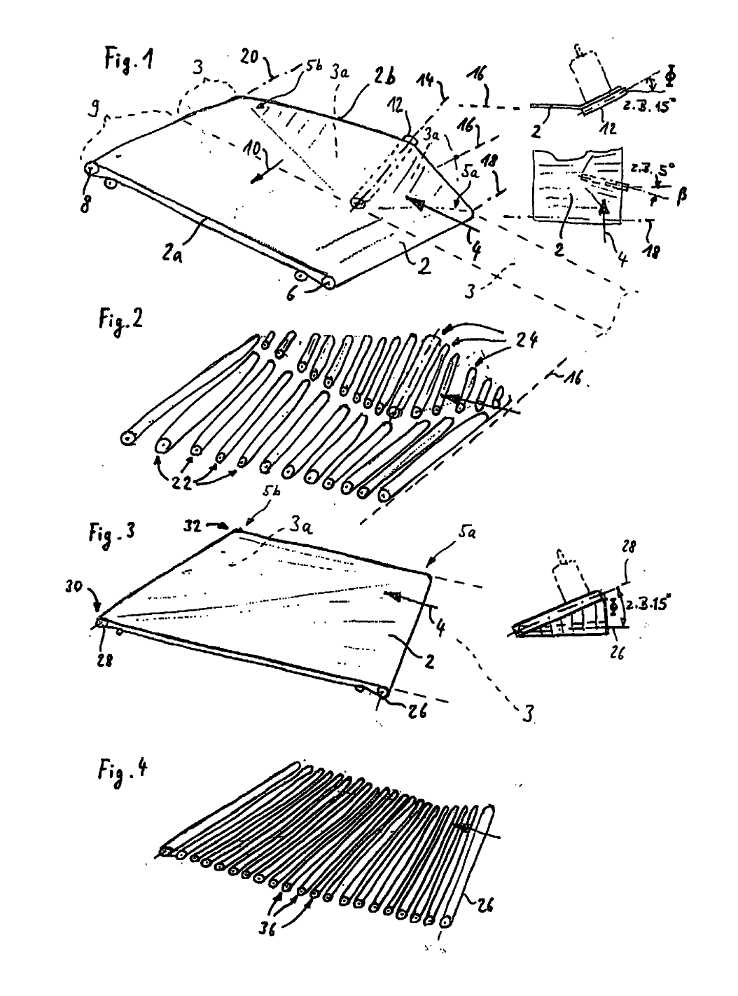

FIG. 3 shows a second embodiment, in which a conveyor belt 2 is guided between a first, horizontal support roller 26 and a second support roller 28 arranged downstream in the conveying direction 4, which is inclined obliquely when seen in the transverse direction 10. As a result, after the conveyor belt 2 leaves the first support roller 26, where it is not yet inclined in the transverse direction 10, it is gradually, or continuously, increasingly inclined in the transverse direction until it reaches the transverse inclination angle of the second support roller 28 and thus forms the conveying surface 3 and the tilting region 3a.

It may be contemplated that a starting point 30 of the second support roller 28, which is located lower than an end point 32, is located at the same height as the first support roller 26, or that the starting point 30 is located higher or lower than the latter.

In this embodiment too, it may be contemplated that the second support roller 28 is adjustable in its transverse angle of inclination Φ, and/or that it is pivotable between a horizontal orientation, parallel to the first support roller 26, to an orientation inclined in the transverse direction 10.

FIG. 4 shows schematically an embodiment corresponding to FIG. 3, in which the belt conveyor 2 is replaced by a roller conveyor, with a first, horizontal support roller 26 and a series of support rollers 36, which are inclined more and more steeply to the horizontal in the trans-verse direction 36. The inclination of a support roller 36 corresponds, for example, to that of the second support roller 28 in the embodiment according to FIG. 3.

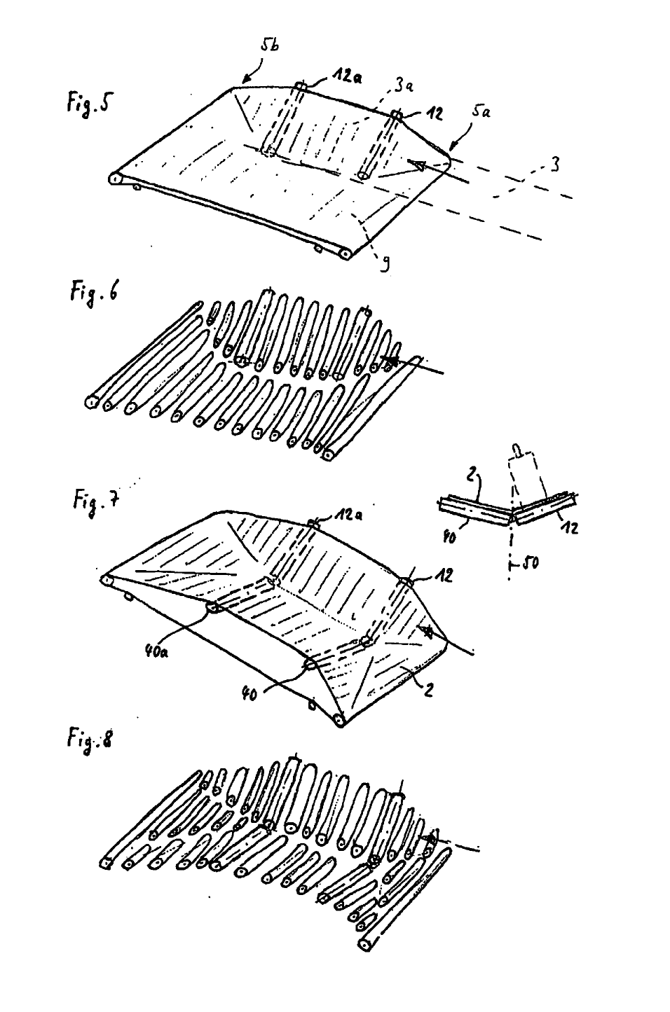

FIG. 5 shows a schematic view of a third embodiment, which corresponds to the first embodiment, but in which, in addition to the support means 12 (support roller), a further support means 12a in the form of a further support roller is provided. The two support rollers 12, 12a are preferably parallel to one another, but in one variant they may also adopt different trans-verse angles of inclination Φ and/or different angles β to the transverse direction.

As FIG. 6 shows, it is also possible in the third embodiment to provide a roller conveyor as a variant, wherein the tilting region 3a is formed by inclined rollers of corresponding lengths. The inclination of the inclined rollers can be adjustable, and the rollers may be movable from a horizontal orientation, in which a horizontal path of a conveying surface is formed when seen in the transverse direction, or from a slightly inclined arrangement, into the more steeply inclined arrangement shown.

By way of an explanation, FIG. 7 shows an embodiment which does not belong to the invention and in which, compared to the third embodiment 2, corresponding support means 40, 40a are provided, in this case support rollers, which give the conveyor belt 2 a generally trough-shaped conveying surface, which slopes from both lateral edges towards the middle. The support means 12, 12a, 40, 40a are preferably arranged symmetrically to a vertical longitudinal central plane 50. In an alternative embodiment, the support means 12, 12a are shorter or longer than the corresponding support means 40, 40a, so that a lowest region of the trough-shaped conveying surface runs off-centre. This variant, too, is conceivable in the form of a roller conveyor, as FIG. 8 shows.

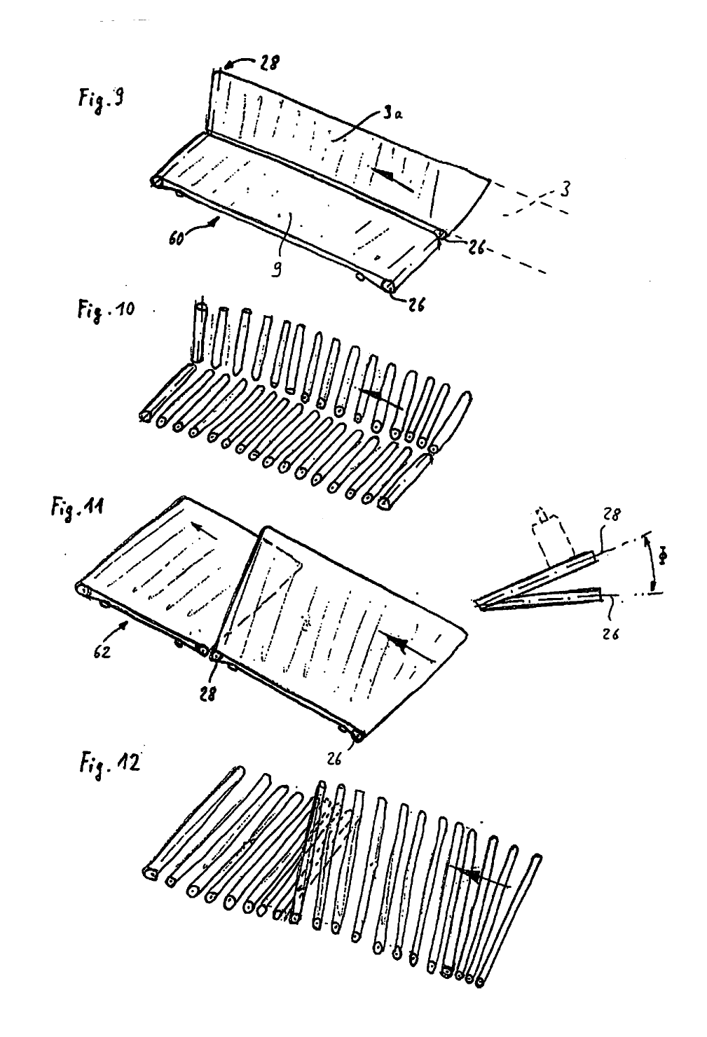

FIG. 9 shows a combination of a belt conveyor configured in accordance with the second embodiment as shown in FIG. 3, which forms the conveying surface 3 and the tilting region 3a, with a collecting conveyor 60 disposed adjacent and parallel thereto with a flat conveying surface. First support rollers 26 may be disposed parallel to one another or with an identical axis of rotation, while a second support roller 28 of the conveyor with a conveying surface 3 running at an increasingly steeper inclination has an angle of inclination to the horizontal ranging between 5° and 30°, just as is illustrated in FIG. 3. The collecting conveyor may run horizontally or have a relatively low transverse or longitudinal inclination.

By way of an explanation, FIG. 10 shows that the embodiment illustrated in FIG. 9 could also be configured as a roller conveyor.

FIG. 11 shows a combination of a conveyor corresponding to the second embodiment according to FIG. 3, with a receiving conveyor 62 having a flat conveying surface. While in this combination the longitudinal directions of the conveyor and receiving conveyor are not offset vis-à-vis one another in the transverse direction, but are substantially or completely aligned with one another, there is a gap region at the transition between the conveyor and the receiving conveyor because of the height offset between the second support roller 28 of the conveyor and the receiving conveyor 62.

FIG. 12 shows that this combination, too, may be configured in the form of roller conveyors.

### LIST OF REFERENCE NUMERALS

2 Conveyor belt
2a, b Lateral edges
3 Conveying surface
3a Tilting region
4 Longitudinal direction (conveying direction)
5a Starting position
5b Final position
6 First support roller (diverting roller)
8 Second support roller (diverting roller)
9 Collecting region
10 Transverse direction
12 Support means (support roller)
12a Further support means (support roller)
14 Axis of rotation von 12
16 Horizontal
18 Axis of rotation of 6
20 Axis of rotation of 8
22 Roller
24 Inclined roller
26 First support roller
28 Second support roller
30 Starting point
32 End point
36 Inclined support roller
40 First corresponding support means (support roller)
40a Second corresponding support means (support roller)
50 Longitudinal central plane
60 Collecting conveyor
62 Receiving conveyor
β Angle
Φ Angle of inclination

FIGS. 1, 3 z.B. 15°=e.g. 15°

1. An apparatus for selectively tipping over an article comprising: an article with a standing surface, when it is standing on a conveying surface extending in a longitudinal direction and is being moved in the longitudinal direction, onto a lateral surface, wherein over at least 90% of its width, the conveying surface, proceeding from an initial orientation, passes over into a tilting region which extends from a starting position in the longitudinal direction as far as a final position, at which the conveying surface has an angle of inclination transverse to the longitudinal direction which is at least 5° and no more than 30° to the horizontal.

2. The apparatus as claimed in claim 1, wherein, beginning at the starting position, the tilting region runs continuously or in a number of steps as far as the final position.

3. The apparatus as claimed in claim 1, wherein the tilting region extends over at least 95% of the width or over the full width of the conveying surface.

4. The apparatus as claimed in claim 1, wherein the conveying surface is configured as a sliding plate or as a belt or roller conveyor.

5. The apparatus as claimed in claim 1, wherein the conveying surface is configured as a belt conveyor with a support means such as a support roller or support plate disposed in the path of the belt, which is inclined in the transverse direction.

6. The apparatus as claimed in claim 1, wherein a collecting region is formed transversely to the longitudinal direction offset next to the conveying surface, next to the tilting region, in the form of a collecting conveyor.

7. The apparatus as claimed in claim 1, wherein a receiving conveyor is disposed adjacent to the final position of the tilting region of the conveying surface, seen in the longitudinal direction, the receiving-conveying surface of which runs at a height corresponding to the height of the tilting region at the starting position of the latter.

8. The apparatus as claimed in claim 1, wherein, seen in the longitudinal direction, a receiving conveyor is disposed adjacent to the final position of the tilting region, the receiving-conveying surface of which follows on from the tilting region in the final position and passes over continuously or step by step in the longitudinal direction into a horizontal orientation, seen transversely to the longitudinal direction.

9. The apparatus as claimed in claim 1, wherein, within the tilting region, the apparatus comprises a belt conveyor, with a conveyor belt, which is guided over a first support means, such as a support or diverting roller, and over a second support means, such as a support or diverting roller, there being at least one support means, such as a support roller or support plate inclined by at least 5° and no more than 30° transverse to the longitudinal direction, disposed between the first and second support means beneath the conveyor belt, and extending between opposing lateral edges of the conveyor belt.

10. The apparatus as claimed in claim 1, wherein, the angle of inclination of the conveying surface within the tilting region is adjustable continuously or step by step.

11. The apparatus as claimed in claim 10, wherein, there is an actuating means which is coupled to a contour detecting means disposed upstream of the tilting region for detecting at least two dimensions of an article to be tipped over as necessary, said actuating means being provided in order to adjust the angle of inclination of the conveying surface.

12. A method for selectively causing a gravity-induced process for tipping an article from a standing surface on which the article is being moved in a longitudinal direction on a conveying surface extending in the longitudinal direction onto a lateral surface, comprising the step of moving the article into an inclined position by means of a tilting region inclined transversely to the longitudinal direction by an angle of inclination of between 5° and 30° to the horizontal.

13. The method as claimed in claim 12, wherein, proceeding from a horizontal orientation of its standing surface, the article is moved continuously or step by step into the inclined orientation.

14. The method as claimed in claim 12, wherein at least two dimensions of the article are detected, contact-free, before the article reaches a final position of the tilting region, and the angle of inclination of the tilting region is adjusted, depending on the dimensions detected, before the article reaches the final position.
